(19) United States
(12) Patent Application Publication
(10) Pub. No.: US 2013/0110794 A1
(43) Pub. Date: May 2, 2013

(54) APPARATUS AND METHOD FOR FILTERING DUPLICATE DATA IN RESTRICTED RESOURCE ENVIRONMENT

(71) Applicant: Chun-Hee Lee, Nonsan-si (KR)

(72) Inventor: Chun-Hee Lee, Nonsan-si (KR)

(73) Assignee: Samsung Electronics Co., Ltd, Suwon-si (KR)

(21) Appl. No.: 13/460,240

(22) Filed: Apr. 30, 2012

(30) Foreign Application Priority Data
Nov. 2, 2011 (KR) 10-2011-0113530

(51) Int. Cl. G06F 17/30

(52) U.S. Cl. 707/692; 707/E17.002

(57) ABSTRACT

An apparatus and method for stably filtering duplicate data in various resource-restricted environments such as a mobile device and medical equipment are provided. The apparatus includes a cell array unit configured to comprise one or more cells; a duplication check unit configured to check whether input data is duplicate and set a value of a cell that matches the input data; and a duplication probability calculation unit configured to, in response to the input data being determined as duplicate data by the duplication check unit, calculate a probability of duplication of the input data using the set value of the cell. Data which may be duplicate data among a large amount of input data is not arbitrarily deleted, but is provided to an application along with a probability of duplication of the data. Accordingly, a false positive error that occurs in Bloom filter is prevented, and thereby system stability can be improved.

### CROSS-REFERENCE TO RELATED APPLICATION(S)

This application claims the benefit under 35 U.S.C. §119(a) of Korean Patent Application No. 10-2011-0113530, filed on Nov. 2, 2011, in the Korean Intellectual Property Office, the entire disclosure of which is incorporated herein by reference for all purposes.

### BACKGROUND

1. Field

The following description relates to a technology for stably filtering duplicate data in various resource-restricted environments.

2. Description of the Related Art

As a mobile technology and a variety of medical devices have been developed, the amount of data generated in real time by the mobile or medical devices has been increasing. Such a great amount of data created by these devices contains quite a large amount of duplicate data. For example, in supply chain management (SCM) by use of radio frequency identification (RFTD), data generated in various methods, such as asset tracking by means of sensors, may include a substantially large amount of duplicate data. For such a device as a mobile device or a medical device that has very restricted resources and requires high stability, it is not easy to efficiently filter a mass of duplicate data. Generally, duplicate data is filtered by use of a hash table, which cannot be loaded on memory if the amount of data is large, and thus the hash table-based filtering has its limitation. To overcome such drawbacks, the Bloom filter has been introduced, but the Bloom filter falsely identifies all data as duplicate data, except explicitly non-duplicate data, and thus deletes the data. This causes a false positive error that erroneously recognizes non-duplicate data as duplicate data, which results in a system being unstable.

### SUMMARY

In one general aspect, there is provided an apparatus for stably filtering duplicate data in a resource-restricted environment, the apparatus comprising: a cell array unit configured to comprise one or more cells; a duplication check unit configured to check whether input data is duplicate and set a value of a cell that matches the input data; and a duplication probability calculation unit configured to, in response to the input data being determined as duplicate data by the duplication check unit, calculate a probability of duplication of the input data using the set value of the cell.

The cell may consist of a bit cell for setting a bit value and a count cell for setting a count value.

The cell array unit may further include one or more hash functions and the duplication check unit computes a hash address associated with the input data using the hash function, set a bit value of a bit cell that matches the computed hash address and increase a count value of a count cell that matches the computed hash address.

The duplication check unit may check the bit value of the bit cell that matches the computed hash address and determines whether the input data is duplicate data based on the check result.

The duplication probability calculation unit may calculate a probability of duplication of the input data using the count value of the count cell that matches the computed hash address.

In another general aspect, there is provided a method of stably filtering duplicate data in a resource-restricted environment, the method comprising: checking whether input data is duplicate; setting a value of a cell that matches the input data; and if the input data is determined as duplicate data, calculating a probability of duplication of the input data using the set value of the cell.

The cell may consist of a bit cell for setting a bit value and a count cell for setting a count value.

The checking of whether the input data is duplicate may include computing one or more hash addresses associated with the input data using one or more hash functions and checking a bit value of a bit cell that matches the computed hash addresses and determining whether the input data is duplicated based on the check result.

The setting of the value of the cell may include setting the bit value of the bit cell that matches each of the computed hash addresses and increasing the count value of the count cell that matches the computed hash addresses.

The calculating of the duplication probability may include calculating the probability of duplication of the input data using the count value of the count cell that matches the computed hash addresses.

Other features and aspects may be apparent from the following detailed description, the drawings, and the claims.

### BRIEF DESCRIPTION OF THE DRAWINGS

FIG. 1 is a diagram illustrating an example of an apparatus for filtering duplicate data.

FIG. 2 is a diagram illustrating an example of a cell array unit of an apparatus shown in the example illustrated in FIG. 1.

FIG. 3 is a diagram illustrating an example of procedures of sequentially setting a value of a cell array unit shown in FIG. 2 with respect to four pieces of input data.

FIG. 4 is a diagram illustrating an example of a method of calculating a probability of duplication of input data.

FIG. 5 is a flowchart illustrating an example of a method of filtering duplicate data.

FIG. 6 is a diagram illustrating an example of application of an apparatus for filtering duplicate data to a resource-restricted mobile device for use in hospital.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

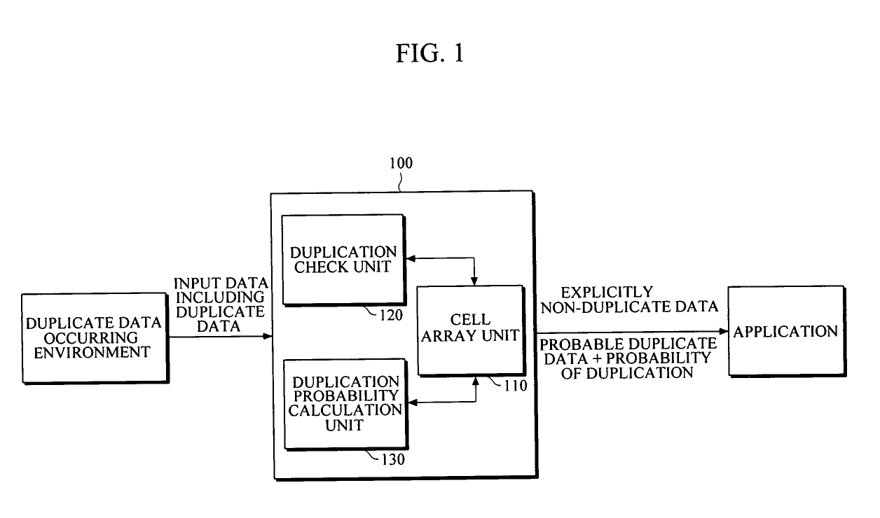

FIG. 1 is a diagram illustrating an example of an apparatus for filtering duplicate data. Referring to FIG. 1, an apparatus 100 may include a cell array unit 110, a duplication check unit 120, and a duplication probability calculation unit 130.

The cell array unit 110 may include one or more cells. The cell array unit 110 may refer to a data structure used to stably filter a large amount of duplicate data in a resource-restricted environment. Examples of the resource-restricted environment may include a mobile device, medical equipment, and any other device which has limitation in memory capacity or computing capability. In particular, maintaining data accuracy and system stability is critically important to medical equipment.

The duplication check unit 120 may check whether input data is duplicated with previous data, and set a value of a cell that matches the input data. The duplication check unit 120 may directly transmit the input data to an application when the input data is explicitly not duplicated, or, if there is a probability of the input data being duplicated, may determine the input data as duplicate data, request the duplication probability calculation unit 130 to calculate a probability of duplication of the duplicate data, and transmit the duplicate data to the application.

In response to the duplication check unit 120 making a determination that the input data is duplicate data, the duplication probability calculation unit 130 may calculate a probability of duplication of the input data using the set value of the cell in the cell array unit 110, and provide the calculated probability to the application.

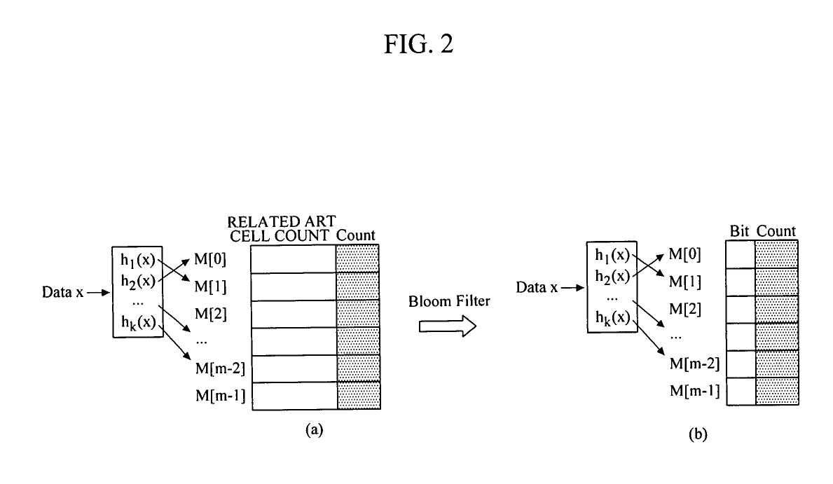

FIG. 2 is a diagram illustrating an example of a cell array unit of an apparatus shown in the example illustrated in FIG. 1. A cell array unit 110 will be described in detail with reference to FIG. 2. (a) in FIG. 2 illustrates an example of a data structure of the cell array unit 110. As shown in FIG. 2(a), the cell array unit 110 may include one or more cells, and more particularly, k hash functions and m cells. Each cell may consist of a bit cell for setting a bit value and a count cell for storing a count value obtained by counting each time each bit cell is set.

(b) in FIG. 2 illustrates an example of a data structure of the cell array unit 110 that is applied to a Bloom filter. The data structure shown in FIG. 2(b) is to overcome a problem of a Bloom filter. Generally, a Bloom filter consists of k hash functions and m bit cells, and, when data is input, computes a hash address associated with the input data using a hash function, and sets a value of a bit cell that matches the computed hash address as 1. If a value of a bit cell that matches a hash address associated with input data includes 0, it is determined that the previous input data and the input data are not duplicate, and if all the values of bit cells with respect to the input data are all 1, it is determined that the previous data and the input data are duplicate, and thus the input data is deleted. However, a general Bloom filter may have 1 as a value of a bit cell that matches a hash address associated with input data which is not actually duplicated, and in this case, a false positive error is generated, which falsely identifies the duplication. This may cause a system to be very unstable.

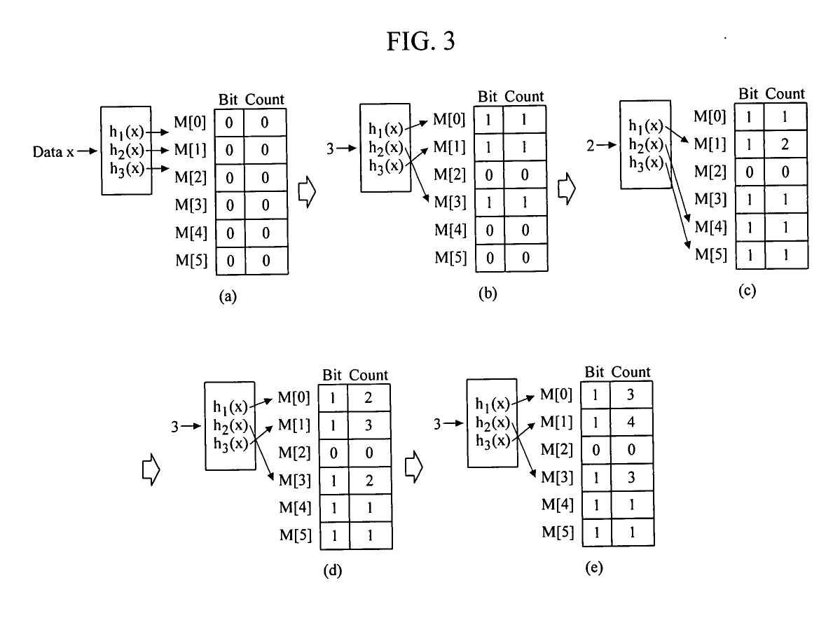

FIG. 3 is a diagram illustrating an example of procedures of sequentially setting a value of a cell array unit shown in FIG. 2 with respect to four pieces of input data. In response to data being input, the duplication check unit 120 may compute a hash address associated with the input data using a hash function of the cell array unit 110, and determine whether or not the input data is duplicated by checking a bit value of a bit cell that matches the computed hash address.

For example, an algorithm shown below is an example of a duplication check algorithm. The duplication check unit 120 may determine that input data is explicitly not duplicate data if any one of bit cells that match the computed hash addresses includes a value of 0, and may determine that input data is duplicate data if values of the bit cells that match the computed hash addresses are all 1. A value of a bit cell that matches the computed hash address is set as 1, and a value of a count cell that matches the hash address is increased by 1.

TABLE 1

```
Algorithm
  Input: Data x
for(i=1;i<=k;i++){// k= the number of hash functions
    M[hi(x)].bit = 1
    if(M[hi(x)].count < MAX_COUNT)
      M[i].count++;
}
if(there exists at least I such that M[hi(x)].bit=0){
    Data x is non-duplicate
}
else{
    Compute the probability with M[h1(x)].count,
    M[h2(x)].count, ... M[hk(x)].count
    Data x is duplicate with the above probability
}
```

In FIG. 3, procedures of processing data of “3,” “2,” “3,” “3” which are sequentially input to the apparatus 100 wherein the cell array unit 110 consists of three hash functions and six cell arrays (six bit cells and six count cells). Procedures of the duplication check unit 120 checking whether input data is duplicate data and procedures of the cell array unit 110 setting a cell value will be described in detail with reference to FIG. 3.

As shown in (a) of FIG. 3, cell values of the cell array unit 110 are all initially set to “0”. When first data “3” is input, the duplication check unit 120 computes hash addresses using three hash functions h₁, h₂, and h₃ and checks values of bit cells of M[0], M[3], and M[1] that match the respective computed addresses. Values of bit cells that match addresses computed according to the first input data are naturally “0”s, and thus the first input data is determined as non-duplicate data, and transmitted to an application. Thereafter, as shown in (b) of FIG. 3, values of the bit cells of M[0], M[3], and M[1] that match the computed addresses are all set to “1”. In addition, values of count cells that match the addresses are increased by 1.

In response to the second data “2” being input, the duplication check unit 120 computes hash addresses, and determines the duplication of data by checking values of bit cells of M[1], M[4], M[5] that match the computed hash addresses. As shown in (b) of FIG. 3, among the bit cells of M[1], M[4], M[5] matching the computed hash addresses, the bit cells of M[4] and M[5] have “0” as their values, and thus the input data “2” is determined as non-duplicate data. In addition, values of the bit cells of M[1], M[4], and M[5] that match the computed hash addresses are all set to “1” and values of the corresponding count cells are increased by 1. As shown in (c) of FIG. 3, the resulting bit cells of M[4] and M[5] are set to “1” and a value of the count cell of M[1] is increased to 2.

Thereafter, in response to the third data “3” being input, the duplication check unit 120 may check the duplication of data through the same procedures as above. That is, values of bit cells of M[0], M[3], and M[1] that match hash addresses computed with respect to the input data “3” are all “1”s (referring to (c) of FIG. 3), and thus the third input data “3” is determined as duplicate data. Then, the bit cells matching the hash addresses are all set to “1,” and values of the corresponding count cells are increased by 1. As shown in (d) of FIG. 3, bit cells of M[0], M[3], and M[1] that match the computed addresses are all set to “1” and the values of the count cells matching the computed hash addresses are increased to 2, 2, and 3, respectively.

In response to the fourth data “3” being input, the duplication check unit 120 checks the duplication and determines the fourth input data “3” as duplicate data through the same procedures as above, and increases values of count cells that match computed hash addresses by 1. In this example, according to an environment in which the example is implemented a value optimal to the count cells may be set in advance as a maximum value, and when reaching the maximum value, each of the count cells is set to an initial value, thereby preventing overflow.

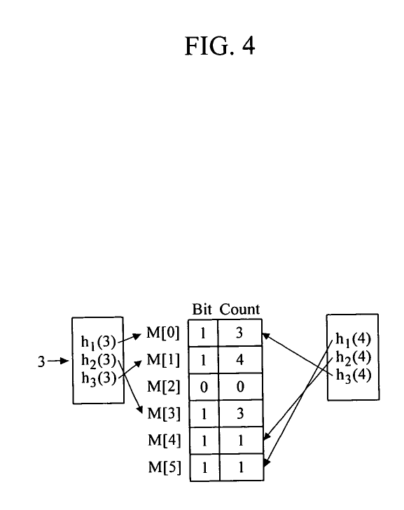

FIG. 4 is a diagram illustrating an example of a method of calculating a probability of duplication of input data. The example shown in FIG. 4 is to describe calculation of a duplication probability when “3” is input as the fifth data to the apparatus shown in FIG. 3 and when “4” is input as the fifth data to the same apparatus. If “3” is input as the fifth input data, the duplication check unit 120 may determine that the input data “3” is duplicate data since values of bit cells of M[0], M[3], and M[1] that match hash addresses computed with respect to the data “3” are all “1”s. In the same manner, if “4” is input as the fifth input data, the duplication check unit 120 may determine that the input data “4” is duplicate data since values of bit cells of M[1], M[4], and M[5] that match hash addresses computed with respect to the data “4” are all “1”s, and may provide the input data to an application.

If the duplication check unit 120 determines input data as duplicate data, the apparatus 100 may calculate the probability of duplication and provide the probability along with the duplicate data without eliminating the duplicate data. The duplication probability calculation unit 130 may calculate the probability of duplication based on a value of a count cell matching a hash address. With respect to input data “3,” values of the count cells of M[0], M[3], and M[1] that match the computed hash addresses are 3, 3, and 4, respectively, and with respect to input data “4,” values of the count cells of M[1], M[4], and M[5] are 1, 1, and 3, respectively. Thus, it may be expected that the probability of duplication with respect to the input data “3” is higher than that for the input data “4.”

Hereinafter, an example of the duplication probability calculation unit 130 calculating the duplication probability value of duplicate data will be described in more detail. The example assumes that the cell array unit 110 consists of k hash functions, m bit cells and m count cells, the k hash functions are independent from one another and they conform to uniform distribution. In addition, the example assumes that input data is a natural number which conforms to uniform distribution between L and H. However, the hash function conforming to uniform distribution is only for purposes of example for convenience of explanation, and the hash function is not limited thereto.

Thus, the duplication probability may be calculated using a variety of mathematical methods, by the assumption of various distributions such as Poisson distribution, normal distribution, and the like. Given count values of count cells that match hash addresses computed with respect to input data “x” are C₁, C₂, . . . Cₖ, respectively, calculating the duplication probability is a matter of choosing one number among 0 to m−1 n*k times. Thus, under the assumption that there is no data duplicated with the input data “x,” the probability of the input data being duplicated may be calculated by formula below.

$$( \frac{( nk ) !}{{\prod }_{i = 1}^{k} {c}_{i} !} ) / ( {m}^{nk} )$$

However, since the above formula yields a duplication probability in disregard of a value of a count cell being increased by data that has been input prior to the current input data “x” and is duplicated with the data “x,” the increased value of the count cell should be removed to calculate an accurate duplication probability. Under the assumption that the input data conforms to uniform distribution between L and H and the total number of input data is n, the average number of duplicate data is d=n/(H−L). Thus, count values resulting from subtracting the count values increased by the duplicate data from the current count values C₁, C₂, . . . Cₖ may be represented as C₁′=C₁−d, C₂′=C₂−d, . . . Cₖ′=Cₖ−d. Accordingly, the accurate duplication probability which removes the values of count cells being increased due to the duplicate data may be represented as formula below.

$$1 - ( \frac{( nk ) !}{{\prod }_{i = 1}^{k} {c}_{i}^{′} !} ) / ( {m}^{nk} )$$

In another example, some applications or environments may request duplicate data to be directly filtered without the provision of an accompanying probability value. In this example, the apparatus 100 may have a threshold set as a criterion to filter duplicate data. The duplication probability calculation unit 130 may check whether a previously set threshold is present. If the threshold is present, the duplication probability calculation unit 130 may skip calculating a probability of duplication of the data that has been determined as duplicate data by the duplication check unit 120 and check whether a value of a count cell corresponding to the data is greater than the threshold. If the value of the count cell is greater than the threshold, the duplication probability calculation unit 130 may determine the data as duplicate data and thus delete it, and otherwise, may determine the data as non-duplicate data and provide it to the application. The threshold may be an optimal value that is achieved by the apparatus 100 through performing measurement multiple times in consideration of system stability, filtering efficiency, filtering duration in a specific environment in which a large amount of data can be generated.

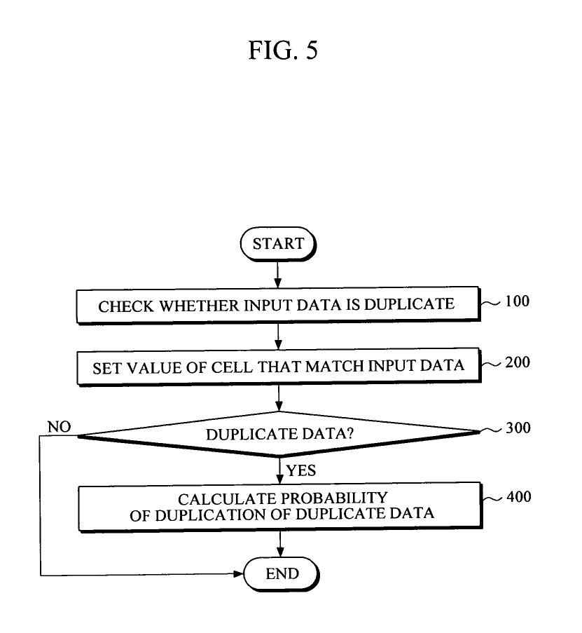

FIG. 5 is a flowchart illustrating an example of a method of filtering duplicate data. To efficiently and stably filter a large amount of duplicate data in a resource-restricted environment, such as a mobile device or medical equipment, it is checked whether input data is duplicated with other data in operation 100.

More specifically, one or more hash addresses associated with the input data are computed using one or more hash functions, and bit values of bit cells that match the computed hash addresses are checked to determine whether the input data is duplicate data. Referring again to FIG. 1, in response to data being input, the duplication check unit 120 computes hash addresses associated with the input data using hash functions, and checks bit values of bit cells that match the computed hash addresses to determine whether the input data is duplicate. For example, if at least one of bit cells matching the hash addresses includes a value of “0,” the duplication check unit 120 may determine that the input data is explicitly not duplicate data, and if all values of the bit cells matching the hash addresses are “1,” the duplication check unit 120 may determine that the input data is duplicate data, and provide it to an application.

Then, a value of a cell that matches the input data is set in operation 200. The cell may consist of a bit cell for setting a bit value and a count cell for setting a count value. The operation of setting the value of the cell may include setting a bit value of the bit cell that matches the computed hash address and increasing a count value of the count cell that matches the hash address. A bit value of the bit cell that matches a computed hash address associated with the input data is set to “1” and a count value of the count cell corresponding to the bit cell is increased by 1.

In response to the input data being determined as duplicate data in operation 300, a probability of duplication of the input data is calculated using the set value of the cell in operation 400. The probability of duplication of the input data may be calculated using the count value of the count cell that matches the computed hash address. It is appreciated that the duplication probability is increased as the count value of the count cell that matches the hash address associated with the input data is greater.

The duplication probability may be calculated using various mathematical schemes by the assumption of a different distribution such as Poisson distribution or normal distribution which is suitable for distribution of hash functions, distribution of data, or an environment. In the above example illustrated in FIG. 4, computation for calculating the probability of duplication of the input data “x” under the assumption that the cell array unit 110 consists of k hash functions, m bit cells and m count cells, wherein the k hash functions are independent from one another and conform to uniform distribution and input data is a natural number and conforms to uniform distribution between L and H.

In addition, data that has been determined as duplicate data by the duplication check unit 120 may be further determined whether it is duplicate data based on a threshold. Instead providing a probability of the data being duplicated, a count value of a cell corresponding to the data may be compared with the threshold which has been previously set as a criterion to filter duplicate data, and if the count value is greater than the threshold, the data may be further determined as duplicate data, and thus be deleted, and otherwise, the data may be determined as non-duplicate data, and transmitted to an application.

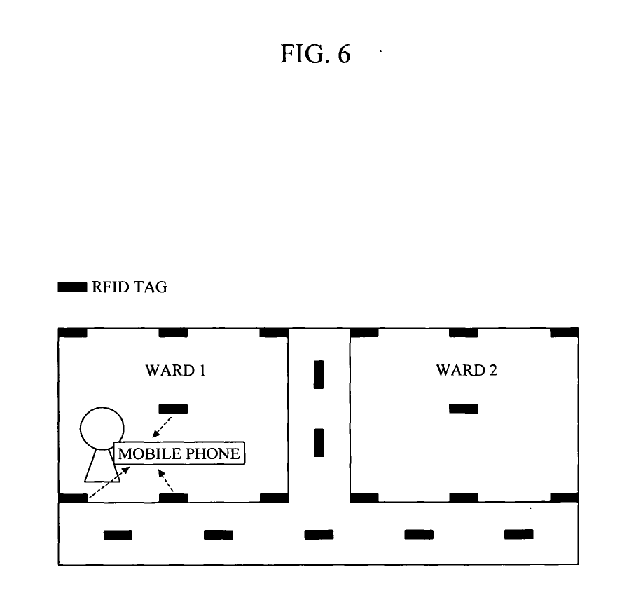

FIG. 6 is a diagram illustrating an example of application of an apparatus for filtering duplicate data to a resource-restricted mobile device for use in hospital. For example, in caring for dementia patients, it is important to track their locations. However, since a global positioning system (GPS) signal may be weak indoors, recently position tracking methods based on radio-frequency identification (RFID) has been increasingly used. As shown in FIG. 6, if RFID tags are deployed around the hospital, patients carrying an RFID reader can track their own location.

However, in this environment, the RFID reader continuously reads all of the tag information, and thereby a large amount of duplicate data can be created. The application of the above-described duplicate data filtering apparatus to such a resource-restricted mobile device can enable deleting the duplicate data efficiently and stably. In addition, information about the movement of the patients may be utilized in medical analysis. Moreover, the duplicate data filtering apparatus described above may be useful for medical analysis devices to filter a vast amount of location tracking data which may contain duplicate data.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus to filter duplicate data in a resource-restricted environment, the apparatus comprising:
a cell array unit configured to comprise one or more cells;
a duplication check unit configured to check whether input data is duplicative, and set a value of a cell of the one or more cells that matches the input data; and
a duplication probability calculation unit configured to, in response to the input data being determined as duplicate data by the duplication check unit, calculate a probability of duplication of the input data using the set value of the cell.

2. The apparatus of claim 1, wherein the cell includes a bit cell for setting a bit value and a count cell for setting a count value.

3. The apparatus of claim 2, wherein:
the cell array unit further comprises one or more hash functions; and
the duplication check unit computes a hash address associated with the input data using one of the hash functions, sets the bit value of the bit cell that matches the computed hash address, and increases the count value of the count cell that matches the computed hash address.

4. The apparatus of claim 3, wherein the duplication check unit checks the bit value of the bit cell that matches the computed hash address, and determines whether the input data is duplicate data based on the checked bit value.

5. The apparatus of claim 3, wherein the duplication probability calculation unit calculates the probability of duplication of the input data using the count value of the count cell that matches the computed hash address.

6. The apparatus of claim 3, wherein the duplication check unit sets the bit value to “1”, and increases the count value by 1.

7. The apparatus of claim 3, wherein the duplication probability calculation unit checks whether a predetermined threshold is present, and in response to the predetermined threshold being present, the duplication probability calculation unit skips the calculating of the probability of duplication of the input data determined as duplicate data.

8. The apparatus of claim 7, wherein the duplication probability calculation unit checks whether the count value is greater than the predetermined threshold, and in response to the count value being greater than the predetermined threshold, the duplication probability calculation unit determines the input data as duplicate data and deletes the input data.

9. The apparatus of claim 1, wherein:
the duplication check unit transmits the input data determined as duplicate data to an application; and
the duplication probability calculation unit transmits the probability of duplication of the input data to the application.

10. A method of filtering duplicate data in a resource-restricted environment, the method comprising:
checking whether input data is duplicative;
setting a value of a cell that matches the input data; and
in response to the input data being determined as duplicate data, calculating a probability of duplication of the input data using the set value of the cell.

11. The method of claim 10, wherein the cell includes a bit cell for setting a bit value and a count cell for setting a count value.

12. The method of claim 11, wherein the checking of whether the input data is duplicative comprises:
computing one or more hash addresses associated with the input data using one or more hash functions;
checking the bit value of the bit cell that matches the computed hash addresses; and
determining whether the input data is duplicated based on the check bit value.

13. The method of claim 12, wherein the setting of the value of the cell comprises:
setting the bit value of the bit cell that matches each of the computed hash addresses; and
increasing the count value of the count cell that matches the computed hash addresses.

14. The method of claim 13, wherein the calculating of the probability of duplication comprises calculating the probability of duplication of the input data using the count value of the count cell that matches the computed hash addresses.

15. The method of claim 13, wherein the bit value is set to “1”, and the count value is increased by 1.

16. The method of claim 13, further comprising:
checking whether a predetermined threshold is present; and
in response to the predetermined threshold being present, skipping the calculating of the probability of duplication of the input data determined as duplicate data.

17. The method of claim 16, further comprising:
checking whether the count value is greater than the predetermined threshold; and
in response to the count value being greater than the predetermined threshold, determining the input data as duplicate data and deleting the input data.

18. The method of claim 10, further comprising transmitting the input data determined as duplicate data and the probability of duplication of the input data to an application.

19. An apparatus comprising:
a processor configured to
increment at least one count value based on input data,
determine whether the input data is probable duplicate data, and
determine a probability of duplication of the input data based on the at least one count value in response to the input data being determined to be probable duplicate data.

20. The apparatus of claim 19, wherein the processor is further configured to transmit the input data determined to be probable duplicate data and the determined probability of duplication of the input data to an application.
